(19) United States
(12) Patent Application Publication
(10) Pub. No.: US 2026/0169300 A1
(43) Pub. Date: Jun. 18, 2026

(54) WEARABLE DISPLAY DEVICE

(71) Applicant: Apple Inc., Cupertino, CA (US)

(72) Inventors: Joel Ebers, Seattle, WA (US); Aidan N. Zimmerman, Poway, CA (US); Barry D. Curtin, Seattle, WA (US); Kevin Ceurter, Olympia, WA (US); Matin Seadat Beheshti, Sunnyvale, CA (US); Sarah F. Talbot, Seattle, WA (US); Timothy Y. Chang, Campbell, CA (US); Trevor S. Chambers, San Diego, CA (US)

(21) Appl. No.: 19/231,305

(22) Filed: Jun. 6, 2025

Related U.S. Application Data
(60) Provisional application No. 63/735,875, filed on Dec. 18, 2024.

(51) Int. Cl. G02B 27/01

(52) U.S. Cl. CPC G02B 27/0176; G02B 2027/0154; G02B 2027/0161

(57) ABSTRACT

A wearable display device can include a display, a housing at least partially surrounding the display, a facial interface coupled to the housing, and an adjustment system disposed in the facial interface. The adjustment system can include an actuation mechanism, and a first locking mechanism moveably coupled to the actuation mechanism. The first locking member can include a first extending member. The adjustment system can further include a toggle coupled to the first locking mechanism and a second locking mechanism movably coupled to the toggle. The second locking mechanism can include a second extending member. The first extending member is configured to move a first distance with respect to the housing and the second extending member is configured to move a second distance with respect to the housing.

### CROSS-REFERENCE TO RELATED APPLICATIONS

This application claims the benefit of U.S. Provisional Application No. 63/735,875, filed 18 Dec. 2024, entitled “WEARABLE DISPLAY DEVICE,” the entire disclosure of which is hereby incorporated by reference.

### FIELD

The present disclosure relates generally to wearable display devices. More particularly, the present disclosure relates to an adjustment system for wearable display devices.

### BACKGROUND

Various components of wearable display devices, such as head-mountable displays (HMDs), can include display screens, viewing frames, securement arms, speakers, batteries, waveguides, and other components, which operate together to provide an immersive experience. User's heads vary in size and shape, and more specifically the distance between a user's eyes, otherwise known as interpupillary distance (IPD), can vary from user to user. Display screens or display lenses provide the most optimal immersive experience when the lenses are positioned directly in front of the user's eyes. However, many HMD lens system can be difficult to adjust and properly position in front of the user's eyes. Therefore, there is a need for an HMD with an effective and simple-to-use an adjustment system to position the lenses in front of the user's eyes.

### SUMMARY

At least one example of the present disclosure includes a wearable display device including a display, a housing at least partially surrounding the display, a facial interface coupled to the housing, and an adjustment system disposed in the facial interface. The adjustment system can include an actuation mechanism, and a first locking mechanism moveably coupled to the actuation mechanism. The first locking member can include a first extending member. The adjustment system can further include a toggle coupled to the first locking mechanism and a second locking mechanism movably coupled to the toggle. The second locking mechanism can include a second extending member. The first extending member can be configured to move a first distance with respect to the housing, and the second extending member can be configured to move a second distance with respect to the housing.

In one example, the adjustment system includes a second actuation mechanism coupled to the second locking mechanism. In one example, the adjustment system includes an arc slider coupling the actuation mechanism and the first locking mechanism. In one example, the adjustment system includes a first cable coupling the toggle and the first locking mechanism. In one example, the adjustment system includes a second cable coupling the toggle and the second locking mechanism. In one example, the first locking mechanism includes a first timing mechanism, and the second locking mechanism includes a second timing mechanism. In one example, the first timing mechanism is coupled to the second timing mechanism. In one example, the adjustment system includes a flex shaft coupling the first timing mechanism to the second timing mechanism. In one example, the first distance and the second distance are substantially the same.

At least one example of the present disclosure includes a wearable device including a display, a housing at least partially surrounding the display, a facial interface extending from the housing, and a facial contact coupled to the facial interface. The facial interface can include an adjustment system. The adjustment system can include an actuation mechanism, a first locking mechanism moveably coupled to the actuation mechanism, and a second locking mechanism movably coupled to the first locking mechanism. The first locking mechanism can include a first extending member and the second locking mechanism can include a second extending member. The first extending member can be configured to move a first distance with respect to the housing and the second extending member can be configured to move a second distance with respect to the housing.

In one example, the adjustment system includes an arc slider coupling the actuation mechanism and the first locking mechanism. In one example, the adjustment system includes a first cable coupling the first locking mechanism and the second locking mechanism. In one example, the first distance is different from the second distance. In one example, the adjustment system includes a toggle coupled to the second locking mechanism. In one example, the adjustment system includes a third locking mechanism coupled to the toggle opposite the second locking mechanism. In one example, the third locking mechanism includes a third extending member. In one example, the third extending member is configured to move a third distance. In one example, the second distance and the third distance are substantially the same. In one example, the adjustment system includes a fourth locking mechanism coupled to the second locking mechanism opposite the first locking mechanism. In one example, the fourth locking mechanism includes a fourth extending member. In one example, the fourth extending member is configured to move a fourth distance. In one example, the first distance and the fourth distance are substantially the same.

At least one example of the present disclosure includes facial interface for a head-mountable device including a facial interface configured to extend between a frame of the head-mountable device and a facial contact. The facial interface can include a slider, a first arc slider extending from the slider, a first locking mechanism movably coupled to the first arc slider, a first cable extending from the first locking mechanism, a second locking mechanism movably coupled to the first cable, a second cable extending from the second locking mechanism, a toggle coupled to the second cable, a third cable extending from the toggle, a third locking mechanism moveably coupled to the toggle, a fourth cable extending from the third locking mechanism, and a fourth locking mechanism movably coupled to the fourth cable. The first locking mechanism can include a first extending member and a first timing mechanism. The second locking mechanism can include a second extending member. The third locking mechanism can include a third extending member. The fourth locking mechanism can include a fourth extending member and a second timing mechanism. In one example, the facial interface includes a flex shaft coupling the first timing mechanism to the second timing mechanism.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates a side view of one example of a wearable display device on a user;

FIG. 2 illustrates a schematic view of one example of a wearable display device and an adjustment system;

FIG. 3 illustrates a side structural view of one example of a locking mechanism;

FIG. 4 illustrates a side structural view of one example of a timing mechanism;

FIG. 5 illustrates a side structural view of one example of a locking mechanism;

FIG. 6 illustrates a side structural view of one example of a toggle; and

FIG. 7 illustrates a schematic view one example of a wearable display device and an adjustment system.

### DETAILED DESCRIPTION

Reference will now be made in detail to representative examples illustrated in the accompanying drawings. It should be understood that the following descriptions are not intended to limit the examples to one preferred example. To the contrary, it is intended to cover alternatives, modifications, and equivalents as can be included within the spirit and scope of the described embodiments as defined by the appended claims.

The present disclosure generally relates to electronic devices. More particularly, the present disclosure relates to wearable display devices. Examples of head-mountable devices can include optical devices, for example glasses lenses, goggles with lenses, transparent display windows, display screens or virtual/augmented reality devices that can include optical components. In these examples, the head-mountable device can be donned on the head of a user such that the display, for example the housing or frame of the display, can be positioned in front of a user's eyes. User's heads can vary in size and shape, and more specifically the distance the cheeks or forehead extends beyond the eyes, can vary from user to user. Display screens or display lenses provide the optimal immersive experience when the display is positioned directly in front of the user's eyes. However, the adjustment of the display to match a user's facial contour can be difficult as small adjustments to the position of the lenses or display of the wearable display devices can affect the immersive experience delivered to the user.

While traditional wearable display devices can include an adjustment system that can adjust the position of the display for a user, traditional adjustment systems do not allow for a symmetrical adjustment of both sides of the display and for adjustment of the angle of the display of the wearable display device relative to the user. The adjustment systems described herein provide for symmetrical adjustment of the display housing and display of the device while accommodating for a variety of users and for users of varying capabilities. The adjustment systems can provide smooth, fine adjustments while positioned on the user. The adjustment systems described herein can provide adjustment of the distance between the display and the user's eyes, as well as adjustment of the angle of the display with respect to the user's eyes. Because the exemplary adjustment systems allow the user to adjust the display while the user is wearing the wearable device, the user has immediate feedback during adjustments, such that the user can precisely adjust the display positioning for the user's specific eyes and facial contour so that the wearable display device can deliver an improved immersive experience to the user.

In at least one example, the wearable display device can include a display housing, a facial interface, and a facial contact. The facial interface can include an adjustment system. The adjustment system can allow for the user to symmetrically adjust a distance and tilt between the display housing and the facial contact. In this way, the user can adjust to optimize eye relief, comfort, safety, or other considerations in all types of events. In one example, the user can adjust the distance while the wearable display device is on the user's head using actuation mechanisms located on an exterior of the facial interface.

In at least one example, the wearable display device can include a system for providing feedback to the user based on the positioning of the display housing and the facial contact. The system can use pressure sensors, cameras, or other sensors to optimize the position of the facial contact in relation to the display housing. The system can provide the user instructions or guidance on adjustments for the wearable display device to optimize the position. In another example, the user can use the display for their own reference in adjusting the wearable display device. Thus, the wearable display device can require less adjustment iterations than adjustments that require the wearable display device to be off the user during adjustments.

The adjustment system can include multiple locking mechanisms that can engage and disengage extending members. The extending members can be seated against the user via the facial contact. The extending members can be used to adjust the distance and tilt between the display housing and the facial contact, and therefore, the user's face and/or eyes. The locking mechanisms can simultaneously engage and disengage the extending members due to movement of the actuation mechanism. When the actuation mechanism is released, the locking mechanisms simultaneous engage the extending members, thereby locking the extending members in position. Thus, the adjustment system can securely fix the position of the extending members, and therefore can securely fix the position of the facial contact, facial interface, and display housing.

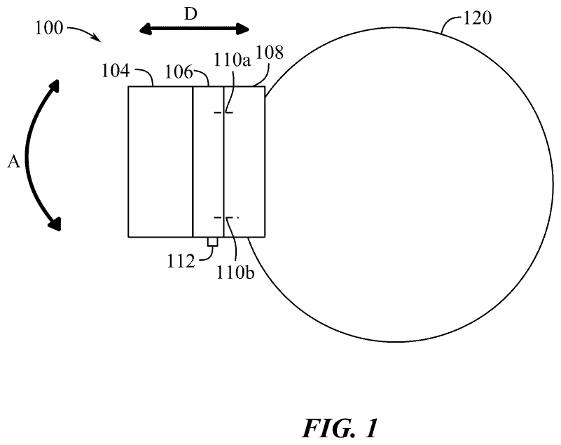

These and other embodiments are discussed below with reference to FIGS. 1-7. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a side view of one example of a wearable display device 100 on a user 120. The wearable display device 100 can be a head-mountable device (HMD) or can be any device or system configured to be worn on the head of a user 120, such as an optical device, smart glasses, alternate/virtual reality goggles, and the like. As shown in FIG. 1, the wearable display device 100 can include at least one display housing 104 which can house a variety of components and systems. In at least one example, the display housing 104 can be configured to secure a display window, display screen, and/or lenses configured to present visual information to the user. For example, the display housing 104 can at least partially surround the display.

In one example of the present disclosure, the wearable display device 100 can include a facial interface 106 which can house an adjustment system. The facial interface 106 can be coupled to the display housing 104, extend from the display housing 104, or be integrated into the display housing 104. The facial interface 106 can include one or more actuation mechanisms 112 as part of the adjustment system. The facial interface 106 can also include extending members 110a and 110b as part of the adjustment system. In one example of the present disclosure, the facial interface 106 can include two, three, four, or more, or less extending members 110a and 110b. The adjustment system of the facial interface 106 can modify a length of the extending members 110a and 110b. By modifying the length of the extending member 110a and 110b, a distance between the facial interface 106 and a facial contact 108 can be modified, and therefore a distance between the user 120 and the display housing 104. In this way, a distance between the user's eyes and the display housing 104 is modified, illustrated by the arrow “D.” The extending members 110a and 110b can also be used to modify an angle between the user 120 and the facial contact 108, illustrated by the arrow “A.”

The facial contact 108 can conform to the head of the user 120, such as a face of the user 120. The facial contact 108 can include flexible, compressive, or deformable materials or elements to conform to the user 120, for example, cloth, fabric, woven material, plastic, rubber, or other suitable material. In some examples, the material of the facial contact can be an opaque material or semi-opaque material. Thus, the facial contact 108 can provide light blocking properties. The facial contact 108 described herein can be movably coupled to the facial interface 106 to adjust a position of the facial contact 108 with respect to the facial interface 106. For example, the extending members 110a and 110b can adjust a distance between the facial interface 106 and the facial contact 108. In another example, the extending members 110a and 110b can adjust a tilt or angle between the facial interface 106 and the facial contact 108.

Any of the features, components, and/or parts, of the wearable device 100 including the arrangements and configurations thereof shown in FIG. 1 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 1.

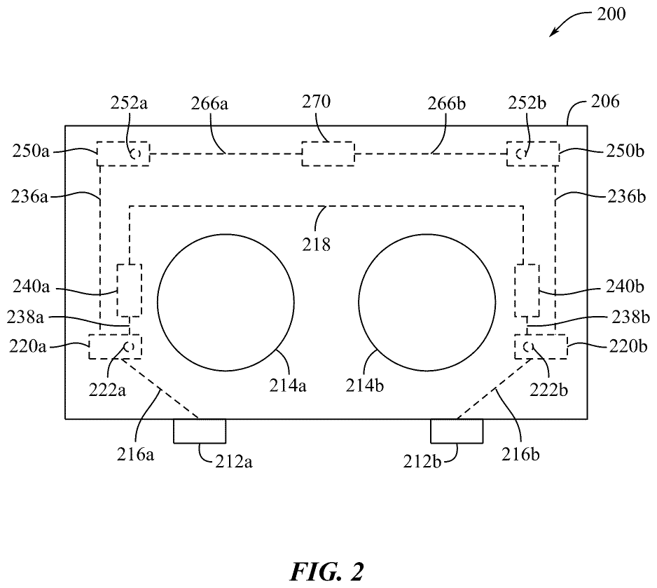

FIG. 2 illustrates a plan or schematic view of one example of a wearable display device 200 and an adjustment system integrated into the facial interface 206. The facial interface 206 can include lenses or apertures 214a and 214b. The lenses or apertures 214a and 214b provide a line of sight from a user to a display, or display housing. Components of the adjustment system can surround the lenses or apertures 214a-b, such that the components do not interfere with the line of sight.

The adjustment system of the facial interface 206 can include actuators or actuation mechanisms 212a and 212b (referred to herein as “actuation mechanisms”), positioned on an exterior of the facial interface 206. Thus, the actuation mechanisms 212a and 212b can be accessible when the wearable display device 200 is donned by a user for adjustment. In another example, the actuation mechanisms 212a and 212b can be positioned on an interior of the facial interface 206 or wearable display device 200, such that the actuation mechanisms 212a and 212b are inaccessible when the wearable display device 200 is donned by the user. The actuation mechanisms 212a and 212b can be a slider, button, lever, an actuator, an actuator solenoid, or other component configured to move between a first position and a second position. The first position can be a locked position. In some examples, the first position can be a default position. The second position can be an unlocked position. The second position can be an adjustment position. A user can move the actuation mechanism from the first position to the second position. In some examples, the actuation mechanisms 212a and 212b can automatically or naturally move, or return, from the second position to the first position. The automatic or natural movement of the actuation mechanisms 212a and 212b to the first position can be caused by a spring bias, cammed surfaces, magnets, and the like. Thus, the actuation mechanisms 212a and 212b can aid in securely fixing the position of components of the adjustment system. In some examples, the actuation mechanisms 212a and 212b can be fixed, or locked, in both the first position and the second position. Additional pressure, action, or movement can, in some examples, be required to move the actuation mechanisms 212a and 212b from the second position to the first position. While two actuation mechanisms 212a and 212b are illustrated in FIG. 2, the adjustment system of the facial interface 206 can include a single actuation mechanism or more than two actuation mechanisms.

The adjustment system of the facial interface 206 can include one or more locks or locking mechanisms 220a, 220b, 250a, and 250b. In one example, the adjustment system can include two lower locking mechanisms 220a and 220b and two upper locking mechanisms 250a and 250b. The lower locking mechanisms 220a and 220b can be positioned below the upper locking mechanisms 250a and 250b. In one example, the lower locking mechanisms 220a and 220b can be positioned such that when the wearable display device 200 is positioned on a user, such as a face of the user, the lower locking mechanisms 220a and 220b are proximal the cheeks of the user. The lower locking mechanism 220a can be positioned such that the lower locking mechanism 220a is proximal a left cheek of the user. The lower locking mechanism 220b can be positioned such that the lower locking mechanism 220b is proximal a right cheek of the user. The upper locking mechanisms 250a and 250b can be above the lower locking mechanisms 220a and 220b. In one example, the upper locking mechanism 250a and 250b can be positioned such that when the wearable display device 200 is positioned on a user, such as on a face of a user, the upper locking mechanisms 250a and 250b are proximal the forehead of the user. Each of the locking mechanisms 220a, 220b, 250a, and 250b can include an extending member 222a, 222b, 252a, and 252b, respectively. The extending members 222a, 222b, 252a, and 252b can apply pressure to a user when the user wears the wearable display device 200, such that movement of the extending members 222a, 222b, 252a, and 252b can modify the distance and/or angle between the user and the display or display housing of the wearable display device 200. For example, the extending members 222a, 222b, 252a, and 252b can adjust a distance between the facial contact and the facial interface by exerting a pressure against the face of the user. To adjust the angle, the extending members 222a and 222b can be extended a different distance that extending members 252a and 252b. While FIG. 2 illustrates four locking mechanisms 220a, 220b, 250a, and 250b and corresponding extending member 222a, 222b, 252a, and 252b, more or less can be included in the adjustment system. In one example, the adjustment system can include two locking mechanisms and corresponding extending members, such as one positioned by the cheek and one positioned by the forehead, two positioned by the cheeks, or two positioned by the forehead. In another example, the adjustment system can include three locking mechanisms and corresponding extending members, such as two positioned by the cheek and one positioned by the forehead.

For movement of the adjustment system, first connectors 216a and 216b can be coupled to the actuation mechanisms 212a and 212b, such that movement of the actuation mechanism 212a and/or 212b from a first position to a second position can cause a first connector 216a and/or 216b to move. The first connectors 216a and 216b can extend from the actuation mechanisms 212a and 212b to the locking mechanisms 220a and 220b. The first connectors 216a and 216b can extend in a linear path, a path with a curvature, or other path between the actuation mechanisms 212a and 212b and the locking mechanism 220a and 220b. The second connectors 236a and 236b can extend from the locking mechanisms 220a and 220b to the locking mechanisms 250a and 250b. The second connectors 236a and 236b can extend in a linear path, a path with a curvature, or other path between the locking mechanism 220a and 220b and the locking mechanisms 250a and 250b. The third connectors 266a and 266b can extend from the locking mechanisms 250a and 250b to a toggle 270. The third connectors 266a and 266b can extend in a linear path, a path with a curvature, or other path between the locking mechanisms 250a and 250b and the toggle 270. The connectors 216a, 216b, 236a, 236b, 266a, and 266b can be tension cables, push/pull cables, rods, flex shafts, or other connection mechanism. The connectors 216a, 216b, 236a, 236b, 266a, and 266b can be flexible or rigid. In some examples, the connectors 216a, 216b, 236a, 236b, 266a, and 266b can be preloaded with tension.

The locking mechanisms 220a and 220b can be substantially similar locking mechanisms in a mirrored orientation. The locking mechanisms 250a and 250b can also be substantially similar locking mechanisms in a mirrored orientation. The locking mechanisms 220a, 220b, 250a, and 250b can be similar locking mechanisms, with different connectors extending therefrom.

For example, the locking mechanisms 220a and 220b can be coupled to the first connectors 216a and 216b and the second connectors 236a and 236b. The locking mechanisms 250a and 250b can be coupled to the second connectors 236a and 236b and the third connectors 266a and 266b. The locking mechanisms 220a, 220b, 250a, and 250b can move between a locked position and an unlocked position. When the locking mechanisms 220a, 220b, 250a, and 250b are in a locked position, the locking mechanisms 220a, 220b, 250a, and 250b can prevent movement of the extending members 222a, 222b, 252a, and 252b. When the locking mechanisms 220a, 220b, 250a, and 250b are in an unlocked position, the locking mechanisms 220a, 220b, 250a, and 250b can enable movement of the extending members 222a, 222b, 252a, and 252b.

The locking mechanisms 220a, 220b, 250a, and 250b can include locking teeth that can engage and disengage based on movement of the actuation mechanisms 212a and 212b. The locking mechanisms 220a, 220b, 250a, and 250b can each be a friction-based lock, such as a barbell lock, that can include a torsional spring surrounding a pin. The torsional spring can release the pin upon actuation to move the locking mechanisms 220a, 220b, 250a, and 250b into an unlocked position. Upon releasing the actuation mechanisms 212a and 212b, or returning to a locked position, the torsional spring can engage the pin. In another example, the locking mechanisms 220a, 220b, 250a, and 250b can be a collet system, such that the locking mechanisms 220a, 220b, 250a, and 250b expand and contract between an unlocked and locked position. In one example, the locking mechanisms 220a, 220b, 250a, and 250b can be bevel gears, such that the connectors 216a, 216b, 236a, 236b, 266a, and 266b can extend from the locking mechanisms 220 a, 220b, 250a, and 250b at a 45-degree angle, a 90-degree angle, or other angle therefrom

The movement of the extending members 220a, 220b, 250a, and 250b can correspond to the type of locking mechanisms 220a, 220b, 250a, and 250b. In one example, the extending members 222a, 222b, 252a, and 252b can include a dampener. The dampener can assist with reducing movement speed of the extending members 220a, 220b, 250a, and 250b during adjustment. For example, the dampener can be a rotatory dampener, a dampening gel, or other dampening mechanism. The extending members 220a, 220b, 250a, and 250b can be a rack and pinion design, such that rotational movement of the locking mechanisms 220a, 220b, 250a, and 250b causes linear movement of the extending members 220a, 220b, 250a, and 250b.

The locking mechanisms 220a and 220b can also include a timing mechanism 340a and 340b. The timing mechanism 220a can be coupled to the timing mechanism 220b via connector 218 such that movement of timing mechanism 240a can translate to movement of the timing mechanism 240b and vice versa. In one example, the timing mechanisms 240a and 240b can aid in synchronizing movement of the extending members 222a and 222b, such that the extending members 222a and 222b move substantially the same distance at substantially the same time. Connector 218 can be positioned above or around the apertures or lenses 214a and 214b, such that the connector 218 does not interfere with the line of sight of the user. In one example, the connector 218 is a flex shaft. In another example, the timing mechanisms 240a and 240b can be linkages and the connector 218 can include one or more joints of the linkage.

The timing mechanisms 240a and 240b can be integrated into the locking mechanisms 220a and 220b or can be coupled to the locking mechanisms 220a and 220b via a coupler 238a and 238b. In one example, the couplers 238a and 238b can include a timing gear on the timing mechanisms 240a and 240b and a corresponding gear or rack of the locking mechanism 220a and 220b.

The toggle 270 can be positioned between the locking mechanisms 250a and 250b. The toggle 270 can aid in returning the adjustment system to a locked position. The toggle 270 can aid in synchronizing unlocking and locking of locking mechanisms 220a, 220b, 250a, and 250b when a single actuation mechanism 212a or 212b is actuated. The toggle 270 can switch the direction of the actuation, such that in a mirrored system, forces generated by moving the actuation mechanism(s) 212a-b can cause forces on either side of the facial interface 206 and adjustment system to go in opposite directions. In one example, the toggle 270 can include one or more springs that are loaded to bias or otherwise return the toggle 270, and the adjustment system, to a locked position. In another example, the toggle 270 can include two racks and a pinion.

In another example, the adjustment system does not include a toggle 270. Instead, the locking mechanisms 250a and 250b can be directly coupled together. The adjustment system can include a spring-loaded lock to aid in returning the components of the adjustment system to a locked position. The spring-loaded lock can be located in line with one of the actuation mechanisms 212a and 212b, one of the locking mechanisms 220a, 220b, 250a, and 250b, or connectors 216a, 216b, 236a, 236b, 266a, or 266b. In one example, the forces of the adjustment mechanism can go in a single direction, such as clockwise or counterclockwise.

In one example, the wearable display device 200 can include one or more cameras positioned as part of a sensing or measurement system to measure eye relief of a user. The wearable display device 200 can include a user interface on a display to assist the user with adjustments. The camera can communicate with the user interface to display information related to adjustments of the wearable display device. For example, the user interface can display instructions for the user to modify a distance of the wearable display device 200. The user interface can display instructions for the user to modify a tilt of the wearable display device 200. The wearable display device 200 can include target field of view information to determine the recommended modification for the wearable display device 200.

In one example, the wearable display device 200 can include one or more sensors. The sensors can measure a pressure, such as the pressure of one or more extending members 222a, 222b, 252a, and/or 252b against the face of a user. A system of the wearable display device 200 can use the sensor output to display adjustment information. For example, the wearable display device 200 can display instructions for the user to modify a distance or tilt of the wearable display device 200. The modification instructions can be based on attempting to achieve an equalized, optimized, or predefined pressure distribution. For example, the system can instruct a user to modify the wearable display device 200 until all sensors have equalized, or substantially equalized pressure, against the face across the extending members 222a, 222b, 252a, and 252b. In another example, the user can adjust the wearable display device 200 to a desired adjustment, such as based on a comfortable fit, and set the adjustment as a preferred adjustment. The system can store the user's preferred adjustment and provide instructions for obtaining the preferred adjustment. In some examples, the system can store preferred adjustments for multiple users. In one example, the system can provide instructions based on the intended use of the wearable display device 200. For example, the system can provide different instructions for using the wearable display device 200 to play virtual sports, watching a movie, other entertainment, comfort fit, or a combination thereof.

In one example, the locking mechanisms 220a, 220b, 250a, and 250b can include actuators, such as electronic actuators. The actuators can receive sensor data and automatically adjust one or more of the extending members 222a, 222b, 252a, and/or 252b to optimize the positioning of the wearable display device 200. The actuators can adjust to optimize for comfort, eye relief, type of use, user preferences, or a combination thereof.

Any of the features, components, and/or parts, of the wearable display device 200 including the arrangements and configurations thereof shown in FIG. 2 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 2.

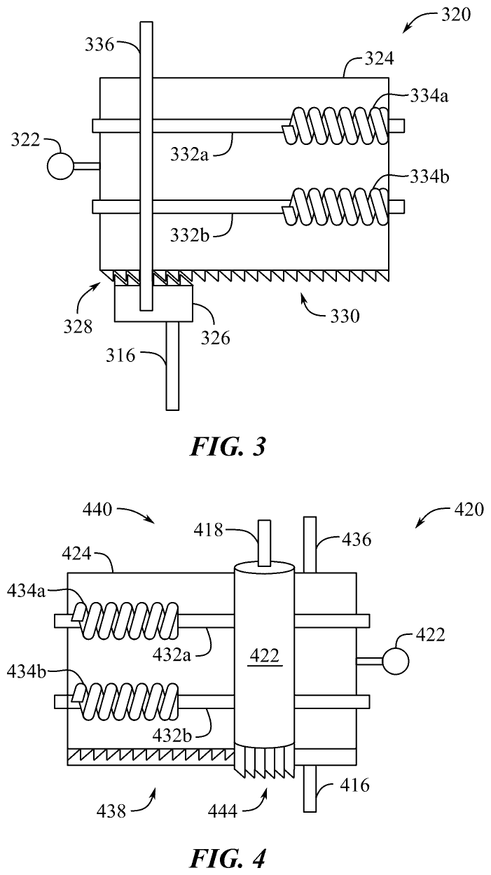

FIG. 3 illustrates one example of a locking mechanism 320. In some examples, the locking mechanism 320 is a lower locking mechanism of the adjustment system. The locking mechanism 320 can unlock an extending member 322 for adjustment of a distance, rotation, or distance and rotation of the display device relative to the user's eyes and face, as described herein.

The locking mechanism 320 can include a first housing 324 and a second housing 326. The second housing 326 can be coupled to a first connector 316. First connector 316 can movably couple the second housing 326 to an actuation mechanism of the adjustment system. When the actuation mechanism is moved, the second housing 326 can move in response. The second housing 326 can be coupled to a second connector 336. The second connector 336 can extend in a different direction away from the housing 326 relative to the first connector 316. As illustrated, the first connector 316 and the second connector 336 can extend opposite one another. While the first connector 316 and the second connector 336 are on opposite sides of the second housing 326, the first connector 316 and the second connector 336 can extend from the second housing 326 at different angles, such as to accommodate a shape of the facial interface. In some examples, the first connector 316 and the second connector 336 can be disposed non-parallel, for example at an angle less than 180-degrees from one another, such as a right angle. The second connector 336 can extend from the locking mechanism 320 to a second locking mechanism, a toggle, or other component of the adjustment system.

The second housing 326 can include locking teeth 328. The locking teeth 328 can extend from the second housing 326 to engage with the first housing 324. For example, the first housing 324 can include locking teeth 330 on an exterior of the first housing 324. In some examples, the locking teeth 330 can be located on a bottom portion of the first housing 324, such that the locking teeth 330 can interact with the second housing 326. However, the first housing 324 and the second housing 326 can interact with other configurations and orientations. The locking teeth 328 can engage with the locking teeth 330 to lock and unlock the locking mechanism 320. The locking teeth 330 can include more locking teeth than the locking teeth 328, such that the locking teeth 328 can engage with the locking teeth 330, and thus the first housing 324, in a plurality of locations.

The locking mechanism 320 can also include extending rods 332a and 332b. Extending rods 332a and 332b can extend through the first housing 324, such that the first housing 324 can translate along the extending rods 332a and 332b. While two extending rods 332 are illustrated, the locking mechanism 320 can include more or less extending rods. The first housing 324 can also include springs 334a and 334b. While two springs 334 are illustrated, the first housing 324 can include more or less springs. For example, the number of springs 334 may be equal to the number of extending rods 332. The springs 334a and 334b can be coupled to the housing 324 on a first end, and the respective extending rods 332a and 332b on a second end. In another example, the springs 334a and 334b can be coupled to the respective extending rods 332a and 332b and be movably fixed in a channel of the first housing 324, such that movement of the extending rods 332a and 332b cause the spring to compress and expand within the channel. The extending member 322 can be fixed to the first housing 324, such that translation of the first housing 324 causes translation of the extending member 322.

In operation, translation of the first connector 316, due to movement of the actuation mechanism, can cause the locking teeth 328 of the second housing 326 to disengage from the locking teeth 330 of the first housing 324. Once the locking teeth 328 and the locking teeth 330 disengage, the first housing 324 can be manually translated along the extending rods 332a and 332b, and thus the extending member 322 can be translated. Translation of the extending member 322 can modify a distance between the display housing (e.g., the display housing 104), and the user (e.g., the user 120). Upon releasing the actuation mechanism, the second housing 326 can return to the locked position and engage with the locking teeth 330, thereby fixing its position.

Any of the features, components, and/or parts, of the locking mechanism 320 including the arrangements and configurations thereof shown in FIG. 3 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 3.

FIG. 4 illustrates one example of a timing mechanism 440. As illustrated, the timing mechanism 440 can be a component of a locking mechanism 420. In some examples, the timing mechanism 440 can be a separate component that can be coupled to the locking mechanism 420.

The locking mechanism 420 can include extending rods 432a and 432b that extend through a housing 424 of the locking mechanism 420. The housing 424 can translate along the extending rods 432a and 432b, causing springs 434a and 434b of housing 424 to selectively compress and decompress. The locking mechanism 420 can be movably coupled to a first connector 416 and a second connector 436. The first connector 416 can cause movement of the locking mechanism 420, thereby causing the locking mechanism 420 to lock and unlock. The housing 424 of the locking mechanism 420 can also include timing gears 438 or teeth on a side of the housing 424. As the housing 424 translates, the housing 424, and therefore the timing gears 438 and an extending member 422, can move in relation to the timing mechanism 440. The timing gears 438 can be a rack for engagement with the timing gear 444 of the timing mechanism 440.

The timing mechanism 440 can include a body 442. The body 442 can be positioned proximal the housing 424 of the locking mechanism 420, such that the timing mechanism 440 can engage with the housing 424. For example, the body 442 of the timing mechanism 440 can include a timing gear 444. The timing gear 444 can engage with the timing gears 438 of the housing 424. As illustrated, the body 442 can be cylindrical and the timing gear 444 can surround the circumferences of the body 442. Thus, translational movement of the housing 424 and timing gears 438 cause rotation of the body 442 by rotationally engaging the timing gear 444. The timing mechanism 440, in combination with the springs 434a and 434b, can limit or restrict the translational movement of the housing 424, and therefore the movement of the extending member 422.

The timing mechanism 440 can also include a timing connector 418. The timing connector 518 can extend between the timing mechanism 440 and a second timing mechanism, and optionally, a second locking mechanism. The timing connector 418 can cause the second timing mechanism to rotate. The rotation of the timing mechanism 440 can cause simultaneous and/or synchronized rotation of the second timing mechanism. The simultaneous and/or synchronized rotation of the timing mechanisms can thus cause simultaneous and/or synchronized translation of the respective locking mechanisms. Thus, the extending member 422 and an extending member of the second timing mechanism and locking mechanism can move the same, substantially the same, or similar distances.

Any of the features, components, and/or parts, of the timing mechanism 440 including the arrangements and configurations thereof shown in FIG. 4 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 4.

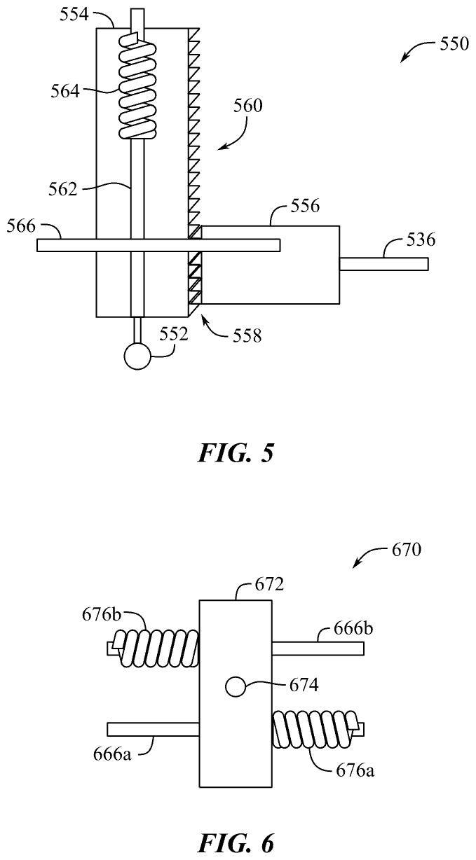

FIG. 5 illustrates a side schematic view of one example of a locking mechanism. In some examples, the locking mechanism 550 is an upper locking mechanism of the adjustment system. The locking mechanism 550 can unlock an extending member 552 for adjustment of a distance, rotation, or distance and rotation of the display device described herein.

The locking mechanism 550 can include a first housing 554 and a second housing 556. The second housing 556 can be coupled to a second connector 536. Second connector 536 can movably couple the second housing 556 to a first, or lower, locking mechanism of the adjustment system. When the actuation mechanism is moved, the first locking mechanism can unlock, thus moving the second connector 536. Movement of the second connector 536 can further cause the second housing 556 of the locking mechanism 550 to move. The second housing 556 can be coupled to a third connector 566. The third connector 566 can extend in a different direction than the second connector 536. As illustrated, the second connector 536 and the third connector 566 can be opposite one another. While the second connector 536 and the third connector 566 are on opposite sides of the second housing 556, the second connector 536 and the third connector 566 can extend from the second housing 556 at different angles, such as to accommodate a shape of the facial interface. In some examples, the second connector 536 and the third connector 566 can be at angle from one another, such as a right angle. The third connector 566 can extend from the locking mechanism 550 to a third locking mechanism, a toggle, or other component of the adjustment system.

The second housing 556 can include locking teeth 558. The locking teeth 558 can extend from the second housing 556 to engage with the first housing 554. For example, the first housing 554 can include locking teeth 560 on an exterior of the first housing 554. In some examples, the locking teeth 560 can be located on a side portion of the first housing 554, depending on the orientation of the first housing 554, such that the locking teeth 560 can interact with the second housing 556. However, the first housing 554 and the second housing 556 can interact with other configurations and orientations. The locking teeth 558 can engage with the locking teeth 560 to lock and unlock the locking mechanism 550. The locking teeth 560 can include more locking teeth than the locking teeth 558, such that the locking teeth 558 can engage with the locking teeth 560, and thus the first housing 554, in a plurality of locations.

The locking mechanism 550 can also include one or more extending rods 562. Extending rod 562 can extend through the first housing 554, such that the first housing 554 can translate along the extending rod 562. While one extending rod 562 is illustrated, the locking mechanism 320 can include more extending rods. The first housing 554 can also include a spring 564. While one spring 564 is illustrated, the first housing 554 can include more springs. For example, the number of springs 564 may be equal to the number of extending rods 562. The spring 564 can be coupled to the first housing 554 on a first end, and the extending rod 562 on a second end. In another example, the spring 564 can be coupled to the extending rod 562 and be movably fixed in a channel of the first housing 554, such that movement of the extending rod 562 causes the spring to compress and expand within the channel. The extending member 552 can be fixed to the first housing 554, such that translation of the first housing 554 causes translation of the extending member 552.

In operation, translation of the second connector 536, due to movement of a first locking mechanism, can cause the locking teeth 558 of the second housing 556 to disengage from the locking teeth 560 of the first housing 554. Once the locking teeth 558 and the locking teeth 560 disengage, the first housing 554 can be manually translated along the extending rod 562, and thus the extending member 552 can be translated. Translation of the extending member 552 can modify a distance between the display housing (e.g., the display housing 104), and the user (e.g., the user 120). Upon releasing the actuation mechanism, the first locking mechanism can return to a locked position, and thus the second housing 556 of the locking mechanism 550 can return to the locked position and engage with the locking teeth 560, fixing the position of the system.

Any of the features, components, and/or parts, of the locking mechanism 550 including the arrangements and configurations thereof shown in FIG. 5 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 5.

FIG. 6 illustrates a perspective view of one example of a toggle 670. The toggle 670 can be used to change a direction of movement within the adjustment system. The toggle 670 can include a body 672. Body 672 can include a pivot 674, such that the body 672 can rotate about an axis of the pivot 674. The pivot 674 can be a pin, a screw, a rod, or other mechanism configured to enable rotation of the toggle 670 about the pivot 674.

Third connectors 666a and 666b can extend from locking mechanisms on opposite sides of the toggle 670 to the toggle 670. The third connectors 666a and 666b can extend through the toggle 670 and/or be coupled to the toggle 670. The toggle 670 can include springs 676a and 676b opposite the third connectors 666a and 666b. In some examples, third connectors 666a and 666b can be coupled to the springs 676a and 676b. The third connectors 666a and 666b can be coupled to a proximal end of the springs 676a and 676b. In some examples, the third connectors 666a and 666b can be coupled to a distal end of the springs 676a and 676b, such that the third connectors 666a and 666b extend through their respective springs 676a and 676b. The third connectors 666a and 666b can be coupled to the toggle 670, with the springs 676a and 676b coupled opposite their respective third connectors 666a and 666b.

The toggle 670 can be configured to switch a direction of movement caused by an actuation mechanism. The toggle 670 can be configured to automatically return the adjustment system to a locked state when the actuation mechanism is released. When a single actuation mechanism is used, the actuation mechanism causes movement in a first direction. Upon the movement reaching the third connector 666a, the third connector 666a can pull on its respective end of the toggle 670 or spring 676a, thereby rotating the toggle 670 about the pivot 674 and decompressing or stretching spring 676a. Thus, spring 676a can apply a different pressure to the toggle 670 than spring 676b and can cause spring 676b to match the tension of spring 676a. The movement of the springs 676a and 676b can cause third connector 666b to move in a second direction, opposite the first direction. Upon release of the actuation mechanism, the tension of the springs 676a and 676b return the toggle 670 to a starting, or locked, position.

Any of the features, components, and/or parts, of the toggle 670 including the arrangements and configurations thereof shown in FIG. 6 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 6.

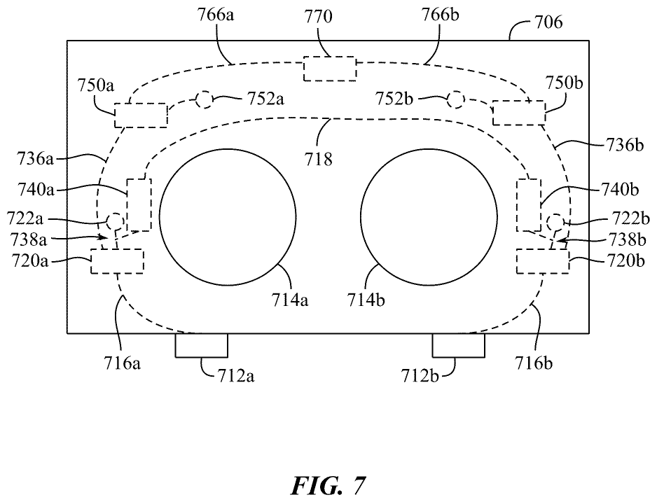

FIG. 7 illustrates a perspective view of one example of a wearable display device 700 and an adjustment system of the facial interface 706. The facial interface 706 includes lenses or apertures 714a and 714b. The lenses or apertures 714a and 714b provide a line of sight from a user to a display, or display housing. Components of the adjustment system can surround the lenses or apertures 714, such that the components do not interfere with the line of sight.

The adjustment system of the facial interface 706 can include actuation mechanisms 712a and 712b, positioned on an exterior of the facial interface 706. Each of the actuation mechanisms 712a and 712b can be a slider, button, or other component configured to move between a first position and a second position. The first position can be a locked position. The first position can be a default position. The second position can be an unlocked position. The second position can be an adjustment position. A user can move the actuation mechanism 712a and 712b from the first position to the second position. The actuation mechanisms 712a and 712b can automatically move, be biased towards, or return, from the second position to the first position. Thus, the actuation mechanisms 712a and 712b can aid in securely fixing the position of components of the adjustment system. While two actuation mechanisms 712a and 712b are illustrated in FIG. 7, the adjustment system of the facial interface 706 can include a single actuation mechanism. Fingers or thumbs of the user can be used to move the actuation mechanism. When the facial interface 706 includes one actuation mechanism 712a or 712b, the user can adjust the facial interface 706 with one hand. In one example, the user moves the actuation mechanisms 212a and/or 212b toward a center region of the facial interface 706.

The adjustment system of the facial interface 706 can include four locking mechanisms 720a, 720b, 750a, and 750b. As illustrated in FIG. 7, two of the locking mechanisms 720a and 720b can be lower locking mechanisms and two of the locking mechanisms 750a and 750b can be upper locking mechanisms. The locking mechanisms 720a and 720b can be positioned below the locking mechanisms 750a and 750b, proximal the cheeks of a user when the wearable display device 700 is on a user's face. The lower locking mechanism 720a can be positioned such that the lower locking mechanism 720a is proximal a left cheek of the user. The lower locking mechanism 720b can be positioned such that the lower locking mechanism 720b is proximal a right cheek of the user. The locking mechanisms 750a and 750b can be positioned above the locking mechanisms 720a and 720b, proximal the forehead of a user when the wearable display device 700 is on a user's face. Each of the locking mechanisms 720a, 720b, 750a, and 750b can include an extending member 722a, 722b, 752a, and 752b, respectively. The extending members 722a, 722b, 752a, and 752b can apply pressure to a user and/or a facial contact, such that when the user wears the wearable display device 700, movement of the extending members 222a, 222b, 252a, and 252b can adjust the distance and/or angle between the user and the display or display housing of the wearable display device 700. To adjust the angle, the extending members 722a and 722b can be extended a different distance that extending members 752a and 752b.

For movement of the adjustment system, first connectors 716a and 716b can be coupled to the actuation mechanisms 712a and 712b, such that movement of the actuation mechanism 712a and/or 712b from a first position to a second position can cause a first connector 716a and/or 716b to move. The first connectors 716a and 716b can extend from the actuation mechanisms 712a and 712b to the locking mechanisms 720a and 720b, such that movement of the first connectors 716a and 716 causes movement of the locking mechanisms 720a and 720b and vice versa. The first connectors 716a and 716b can extend along a path with a curvature around lenses or apertures 714a and 714b. The first connectors 716a and 716b can be an arc slider.

The second connectors 736a and 736b can extend from the locking mechanisms 720a and 720b to the locking mechanisms 750a and 750b. Movement of the locking mechanisms 720a and 720b can cause movement of the second connectors 736a and 736b and vice versa. Movement of the second connectors 736a and 736b can cause movement of the locking mechanisms 750a and 750b and vice versa. The second connectors 736a and 736b can extend along a path with a curvature around lenses or apertures 714a and 714b. The second connectors 736a and 736b can be a push/pull cable.

The third connectors 766a and 766b can extend from the locking mechanisms 750a and 750b to a toggle 770. Movement of the locking mechanisms 750a and 750b can cause movement of the third connectors 766a and 766b and vice versa. Movement of the third connectors 766a and 766b can cause movement of the toggle 770 and vice versa. The third connectors 766a and 766b can extend along a path with a curvature around lenses or apertures 714a and 714b. The third connectors 766a and 766b can be a push/pull cable.

The locking mechanisms 720a and 720b can be substantially similar locking mechanisms in a mirrored orientation. The locking mechanisms 750a and 750b can also be substantially similar locking mechanisms in a mirrored orientation. The locking mechanisms 720a, 720b, 750a, and 750b can be similar locking mechanisms, with different connectors extending therefrom and different orientations.

The locking mechanisms 720a, 720b, 750a, and 750b can move between a locked position and an unlocked position. When the locking mechanisms 720a, 720b, 750a, and 750b are in a locked position, the locking mechanisms 720a, 720b, 750a, and 750b can prevent movement of the extending members 722a, 722b, 752a, and 752b. When the locking mechanisms 720a, 720b, 750a, and 750b are in an unlocked position, the locking mechanisms 720a, 720b, 750a, and 750b can enable movement of the extending members 722a, 722b, 752a, and 752b. The locking mechanisms 720a, 720b, 750a, and 750b can include locking teeth that can engage and disengage based on movement of the actuation mechanisms 712a and 712b.

The locking mechanisms 720a and 720b can also include a timing mechanism 740a and 740b. The timing mechanism 720a can be coupled to the timing mechanism 720b via connector 718 such that movement of timing mechanism 740a can translate to movement of the timing mechanism 740b and vice versa. In one example, the timing mechanisms 740a and 740b can aid in synchronizing movement of the extending members 722a and 722b, such that the extending members 722a and 722b move substantially the same distance at substantially the same time. Connector 718 can be positioned above or around the apertures or lenses 714a and 714b, such that the connector 718 does not interfere with the line of sight of the user. For example, the connector 718 can follow a curvature around the lenses or apertures 714a and 714b. In one example, the connector 718 is a flex shaft. The timing mechanisms 740a and 740b can be integrated into the locking mechanisms 720a and 720b or can be coupled to the locking mechanisms 720a and 720b via a coupler 738a and 738b. In one example, the couplers 738a and 738b can include a timing gear on the timing mechanisms 740a and 740b and a corresponding gear or rack of the locking mechanism 720a and 720b.

The toggle 770 can be positioned between the locking mechanisms 750a and 750b. The toggle 770 can aid in returning the adjustment system to a locked position. The toggle 770 can aid in synchronizing unlocking and locking of locking mechanisms 720a, 720b, 750a, and 750b when a single actuation mechanism 712a or 712b is actuated, or when both actuation mechanisms 712a and 712b are actuated. The toggle 770 can switch the direction of the actuation, such that in a mirrored system, forces generated by moving the actuation mechanism(s) 712a-b can cause forces on either side of the facial interface 706 and adjustment system to go in opposite directions. In one example, the toggle 770 can include one or more springs that are loaded to return the toggle 770, and the adjustment system, to a locked position.

Any of the features, components, and/or parts, of the wearable display device 700 including the arrangements and configurations thereof shown in FIG. 7 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 7.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A head-mountable device comprising:
a display;
a housing at least partially surrounding the display;
a facial interface coupled to the housing; and
an adjustment system disposed in the facial interface, the adjustment system comprising:
an actuation mechanism;
a first locking mechanism moveably coupled to the actuation mechanism, the first locking mechanism comprising a first extending member;
a toggle coupled to the first locking mechanism; and
a second locking mechanism movably coupled to the toggle, the second locking mechanism comprising a second extending member;
wherein:
the first extending member is configured to move a first distance relative to the housing; and
the second extending member is configured to move a second distance relative to the housing.

2. The head-mountable device of claim 1, wherein the adjustment system further comprises a second actuation mechanism coupled to the second locking mechanism.

3. The head-mountable device of claim 1, wherein the adjustment system further comprises an arc slider coupling the actuation mechanism and the first locking mechanism.

4. The head-mountable device of claim 1, wherein the adjustment system further comprises a first cable coupling the toggle and the first locking mechanism.

5. The head-mountable device of claim 4, wherein the adjustment system further comprises a second cable coupling the toggle and the second locking mechanism.

6. The head-mountable device of claim 1, wherein:
the first locking mechanism further comprises a first timing mechanism; and
the second locking mechanism further comprises a second timing mechanism.

7. The head-mountable device of claim 6, wherein the first timing mechanism is coupled to the second timing mechanism.

8. The head-mountable device of claim 7, wherein the adjustment system further comprises a flex shaft coupling the first timing mechanism to the second timing mechanism.

9. The head-mountable device of claim 1, wherein the first distance and the second distance are substantially the same.

10. A wearable device comprising:
a display;
a housing at least partially surrounding the display;
a facial interface extending from the housing, the facial interface comprising an adjustment system; and
a facial contact coupled to the facial interface,
the adjustment system comprising:
an actuator;
a first lock moveably coupled to the actuator, the first lock comprising a first extending member; and
a second lock movably coupled to the first lock, the second lock comprising a second extending member;
wherein:
the first extending member is configured to move a first distance relative to the housing; and
the second extending member is configured to move a second distance relative to the housing.

11. The wearable device of claim 10, wherein the adjustment system further comprises an arc slider coupling the actuator and the first lock.

12. The wearable device of claim 10, wherein the adjustment system further comprises a first cable coupling the first lock and the second lock.

13. The wearable device of claim 10, wherein the first distance is different from the second distance.

14. The wearable device of claim 10, wherein the adjustment system further comprises a toggle coupled to the second lock.

15. The wearable device of claim 14, wherein the adjustment system further comprises a third lock coupled to the toggle opposite the second lock, the third lock comprising a third extending member, wherein the third extending member is configured to move a third distance.

16. The wearable device of claim 15, wherein the second distance and the third distance are substantially the same.

17. The wearable device of claim 14, wherein the adjustment system further comprises a fourth lock coupled to the second lock opposite the first lock, the fourth lock comprising a fourth extending member, wherein the fourth extending member is configured to move a fourth distance.

18. The wearable device of claim 17, wherein the first distance and the fourth distance are substantially the same.

19. A facial interface for a head-mountable device, the facial interface configured to extend between a frame of the head-mountable device and a facial contact, the facial interface comprising:
a slider;
a first arc slider extending from the slider;
a first locking mechanism movably coupled to the first arc slider, the first locking mechanism comprising a first extending member and a first timing mechanism;
a first cable extending from the first locking mechanism;
a second locking mechanism movably coupled to the first cable, the second locking mechanism comprising a second extending member;
a second cable extending from the second locking mechanism;
a toggle coupled to the second cable;
a third cable extending from the toggle;
a third locking mechanism moveably coupled to the toggle, the third locking mechanism comprising a third extending member;
a fourth cable extending from the third locking mechanism; and
a fourth locking mechanism movably coupled to the fourth cable, the fourth locking mechanism comprising a fourth extending member and a second timing mechanism.

20. The facial interface of claim 19, further comprising a flex shaft coupling the first timing mechanism to the second timing mechanism.
